(19) United States
(12) Patent Application Publication
(10) Pub. No.: US 2026/0357611 A1
(43) Pub. Date: Nov. 12, 2026

(54) CUSTOMIZABLE TRIM ASSEMBLIES FOR DOOR LOCKS

(71) Applicant: Schlage Lock Company LLC, Carmel, IN (US)

(72) Inventors: Manjunath Shetty, Udupi (IN); Saagar Mohammed, Alappuzha-Kerala (IN); Vijayakumar Mani, Karnataka (IN); Aida K. N. Watson, Noblesville, IN (US); Autumn A. Groleski, Noblesville, IN (US); Joel M. Walker, Indianapolis, IN (US)

(21) Appl. No.: 19/205,173

(22) Filed: May 12, 2025

(51) Int. Cl. E05B 9/00; E05B 9/08

(52) U.S. Cl. CPC E05B 9/002; E05B 9/08

(57) ABSTRACT

A customizable trim assembly for door locks that can include an escutcheon and an interchangeable trim plate, and, optionally, a bezel. Either or both the trim plate and the bezel can be configured for aesthetic customization, including via colors, patterns, designs and finishes, based on customer preferences. Additionally, the trim insert can be constructed from a material that can accommodate customization via one or more painting or printing techniques, among other forms of customization. The trim assembly can utilize a spring-loaded latch assembly for selective coupling, and decoupling, of a bezel that houses the trim plate to the escutcheon. However, other reusable coupling means can be utilized, including magnetic coupling and coupling using a stretch release adhesive, among other manners of selective coupling, that can be used to securely mount either or both the bezel and the trim insert to the escutcheon.

### FIELD OF THE DISCLOSURE

The present disclosure generally relates to trim assemblies for door locks, and more particularly, but not exclusively, to door hardware including functional trim assemblies that include customizable and interchangeable trim inserts.

### BACKGROUND

In addition to providing structural support for the handle, door trims typically also enhance the overall aesthetic of the door lock. Traditionally, with respect to the aesthetics of the door lock, customers are limited to selecting from predefined, and generally limited, options that are preset by the manufacture of the door lock.

### SUMMARY

The present disclosure may comprise one or more of the following features and combinations thereof.

In one embodiment of the present disclosure, a trim assembly is provided for a door lock. The trim assembly can include a base that can be configured to be secured to a door hardware apparatus, and a bezel. At least one of the bezel and the base can have a protrusion and the other of the bezel and the base can have a cavity positioned to receive the protrusion. The trim assembly can also include a trim insert that can be configured to be securely positioned within at least a portion of the bezel. The trim insert can have a customizable front side that is at least partially externally visible through a front opening of the bezel. The trim assembly can also include a latch coupled to the base and configured for selective displacement between an extended position and a retracted position, the latch being in the extended position to lockingly couple the bezel to the base at least when the protrusion is received in the cavity. Additionally, the bezel can be configured for a pivotal displacement of the bezel about a location at which the protrusion is received in the cavity, a portion of the bezel being configured to contact the latch during the pivotable displacement to displace the latch from the extended position to the retracted position until the bezel is positioned to be lockingly coupled to the base.

In another embodiment, a trim assembly is provided for a door lock. The trim assembly can include a base that can be configured to be secured to a door hardware apparatus, and a bezel that can have a front opening and a rear opening. The front opening can be smaller than the rear opening, and the front opening can be adjacent to a front side of the bezel, the rear opening being adjacent to a rear side of the bezel. The trim assembly can also include a trim insert, at least a portion of the trim insert being configured to be securely positioned within the rear opening of the bezel. Additionally, the trim insert can have a customizable front side that is at least partially externally visible through the front opening of the bezel. The trim assembly can also include a latch assembly that can be coupled to the base, the latch assembly comprising a biasing element and a latch. The biasing element can be configured to provide a biasing force to bias the latch to an extended position, and the latch can be selectively displaceable between the extended position and a retracted position, the latch being in the extended position to lockingly couple the bezel to the base.

In a further embodiment of the present disclosure, a trim assembly is provided for a door lock. The trim assembly can include a base that can be configured to be secured to a door hardware apparatus. The base can have a base perimeter wall having an outer side, the outer side having a cavity. The base can further have a first opening in the base perimeter wall and a second opening in a backing wall of the base. The backing wall can extend between at least a portion of a pair of opposing sidewalls of the base perimeter wall. The second opening can be sized to receive insertion of a spindle that can be configured to be coupled to a handle of the door lock. The trim assembly can also include a bezel that can have a bezel perimeter wall and a front wall, an inner side of the bezel perimeter wall having a protrusion and a recess. The protrusion and the recess can be positioned on opposing walls of the bezel perimeter wall. Further, the protrusion can be positioned to be received within the cavity of the base. The front wall can define a front opening, and the bezel perimeter wall can define a rear opening, the front opening being smaller than the rear opening. The trim assembly can also include a trim insert, at least a portion of the trim insert being configured to be securely positioned within the rear opening of the bezel. Additionally, the trim insert can have a customizable front side that is at least partially externally visible through the front opening of the bezel. The trim assembly can also include a latch assembly that can be coupled to the base. The latch assembly can include a biasing element and a latch, the biasing element being configured to provide a biasing force to bias the latch to an extended position. The latch can be selectively displaceable through the first opening of the base and between the extended position and a retracted position. Additionally, the latch can be in the extended position to lockingly couple the bezel to the base, the latch having a locking body that is removably positioned in the recess of the bezel when the bezel is lockingly coupled to the base.

These and other features of the present disclosure will become more apparent from the following description of the illustrative embodiments.

### BRIEF DESCRIPTION OF THE DRAWINGS

The disclosure described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates a partially exploded assembly view of an exemplary door hardware apparatus mounted to a door.

FIG. 2 illustrates a front side perspective view of an exemplary trim assembly that includes a handle.

FIG. 3 illustrates an exploded front side perspective view of the trim assembly shown in FIG. 2 but without the handle.

FIG. 4 illustrates a bottom, front side perspective view of an exemplary escutcheon for the trim assembly shown in FIG. 2.

FIG. 5 illustrates a top, rear perspective view of the escutcheon shown in FIG. 4.

FIG. 6 illustrates a side view of at least a portion of an exemplary latch assembly.

FIGS. 7 and 8 illustrate rear and front side perspective views, respectively, of the latch assembly shown in FIG. 6.

FIG. 9 illustrates a bottom, rear side perspective view of an exemplary bezel for the trim assembly shown in FIG. 2.

FIG. 10 illustrates a top, rear side perspective view of the bezel shown in FIG. 9.

FIG. 11 illustrates a cross-sectional view of a portion of the illustrated trim assembly generally taken along line 11-11 of FIG. 2.

FIG. 12 illustrates a cross-sectional view of a portion of the illustrated trim assembly generally taken along line 12-12 of FIG. 2 with at least the handle removed.

FIG. 13 illustrates a front side perspective view of another exemplary trim assembly that includes a latch assembly that utilizes a plurality of magnets.

FIG. 14 illustrates a front side perspective view of an exemplary escutcheon for the trim assembly shown in FIG. 13.

FIG. 15 illustrates a front side perspective view of an exemplary trim plate and bezel for the trim assembly shown in FIG. 13.

FIG. 16 illustrates a front, top side perspective view of the exemplary trim assembly shown in FIG. 3.

FIG. 17 illustrates a front, bottom side perspective view of the exemplary trim assembly shown in FIG. 16.

FIG. 18 illustrates a front view of the exemplary trim assembly shown in FIG. 16.

FIG. 19 illustrates a left side view of the exemplary trim assembly shown in FIG. 16.

FIG. 20 illustrates a right side view of the exemplary trim assembly shown in FIG. 16.

FIG. 21 illustrates a bottom view of the exemplary trim assembly shown in FIG. 16.

FIG. 22 illustrates a bottom view of the exemplary trim assembly shown in FIG. 16.

Corresponding reference numerals are used to indicate corresponding parts throughout the several views.

### DETAILED DESCRIPTION

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

A number of features described below may be illustrated in the drawings in phantom. Depiction of certain features in phantom is intended to convey that those features may be hidden or present in one or more embodiments, while not necessarily present in other embodiments. Additionally, in the one or more embodiments in which those features may be present, illustration of the features in phantom is intended to convey that the features may have location(s) and/or position(s) different from the locations(s) and/or position(s) shown.

Embodiments of the subject disclosure generally relate to customizable trim assemblies for door locks that can include an escutcheon or base, a customizable, or interchangeable, trim insert, and a bezel. Either or both the customizable trim insert, also referred to as a face plate, and the bezel can be removable and/or replaceable to be customized, at least aesthetically, according to the preferences of the individual customer and/or to accommodate interchangeability among a variety of trim plates 106 that may, or may not, have different ornamental appearances, including characteristics. Such customization can, for example, be at least with respect to one or more of the color(s), design(s), pattern(s), image(s), as well as various combinations thereof, of and/or depicted or displayed on, the trim insert and/or bezel. Additionally, such an approach can accommodate the customization of the finish on either or both the trim insert and the bezel, including, with respect to the finish painted or otherwise applied to the trim insert and/or bezel.

The trim insert and/or bezel can thus be constructed from one or more materials, including a plastic material and/or metallic material, as well as a combination thereof, that can accommodate customization via one or more customization techniques, such as, for example, printing techniques, including, for example, screen printing, and/or painting, among other customization techniques. By allowing customers to customize, and thus individualize, either or both the trim insert and bezel, embodiments of the subject disclosure can overcome traditional limitations regarding limited fixed, or predefined, trim assembly designs and finishes. Additionally, such customization can enhance the aesthetic appeal and personal satisfaction of the trim assembly, as well as accommodate providing customers with a trim assembly having a unique look tailored to the customer's individual preferences.

According to certain embodiments, the trim insert is configured to be placed inside the bezel. The bezel can be designed to be coupled to an escutcheon at one or more locations about the bezel. For example, according to certain embodiments, at least a portion the bezel can be configured to hook into, or otherwise matingly engage, with one or more depressions or cavities of an escutcheon, including one or more depressions or cavities that may extend along a portion(s), or entirety of, a top portion of the escutcheon. According to such an embodiment, when coupling the bezel, with the trim insert placed in the bezel, the bezel may be non-parallel to relative to the escutcheon such that a portion of the bezel can be received in at least a portion of the one or more depressions in the escutcheon. Thus, for example, the top portion of the bezel may be engaged with, or received by, the one or more depressions in the top portion of the escutcheon while the bottom portion of the bezel is generally disengaged with, and adjacent to a front portion of the escutcheon. In such a situation, upon the portion of the top portion of the bezel being engaged with/received by the corresponding one or more depressions in the top portion of the escutcheon, the bottom portion of the bezel can be pushed against the escutcheon such that other portions of the bezel can matingly engage the escutcheon, including, for example, be received in other portions, or additional depressions in the escutcheon, so as to position and/or secure the bezel about the escutcheon. Further, while the foregoing example is discussed in terms of features of the top and bottom portions of the bezel and escutcheon, such an example is also applicable to other portions of the bezel and escutcheon, including, sidewalls, or, alternatively, for embodiments in which the above-mentioned depressions are in the bottom portion, rather than top portion, of the escutcheon, among other variations.

Additionally, or alternatively, the trim insert and bezel can also be selectively coupled to the escutcheon via a latch assembly. According to certain embodiments, the latch assembly can include one or more biasing elements, and thus, for example, be a spring loaded latch. With respect to the above-discussed example, as the bottom portion of the bezel is pushed against the escutcheon, and the bezel moves onto, or about, the escutcheon, the bezel can engage the spring loaded latch of the latch assembly in a manner that at least temporarily retracts the spring loaded latch, including, for example, into the escutcheon. Further, the bezel can include an aperture that is positioned to, once the bezel is properly positioned around the escutcheon, accommodate the spring loaded latch moving from the retracted position to an extended position at which at least a portion of the spring loaded latch is received within the aperture in a manner that at least assists in locking the bezel, and thus the trim plate, to the escutcheon. Further, the aperture can, according to certain embodiments, be accessible from outside of the trim assembly to accommodate selected displacement of the spring loaded latch to the retracted position so that the bezel, and thus trim plate, can be selectively decoupled, and thus removed, from the escutcheon. The removed trim assembly and/or bezel can then undergo customization, change in customization, interchangeability, or replacement.

While the foregoing example is discussed with respect to the latch assembly including a spring loaded latch, additionally, or alternatively, the latch assembly and trim assembly can include other generally reusable coupling methods to secure the trim plate to the trim assembly, including, but not limited to, trim assemblies that may not include a bezel. For example, according to certain embodiments, magnets, including a series of magnets, can be used to provide a magnetic attraction to selectively couple at least the trim plate to either or both the bezel and the escutcheon. Additionally, or alternatively, magnets can also be utilized to secure the bezel to the escutcheon. The position and strength of the magnets can be designed to enhance the ergonomic appeal for applications in which a customer may install at least the trim assembly. However, a variety of other reusable coupling means, in addition to, or in lieu of, magnets can be utilized, including, but not limited to, use of stretch release adhesives or hook and loop material, among others. Such configurations can at least assist in firmly coupling the trim plate, with or without the bezel, to the escutcheon in a manner in which installation of the trim assembly is relatively easy and may not require tools.

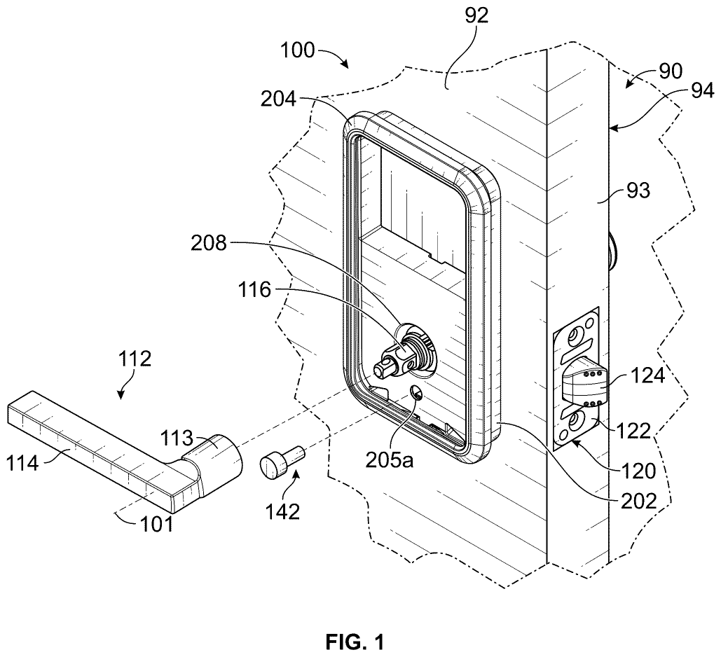

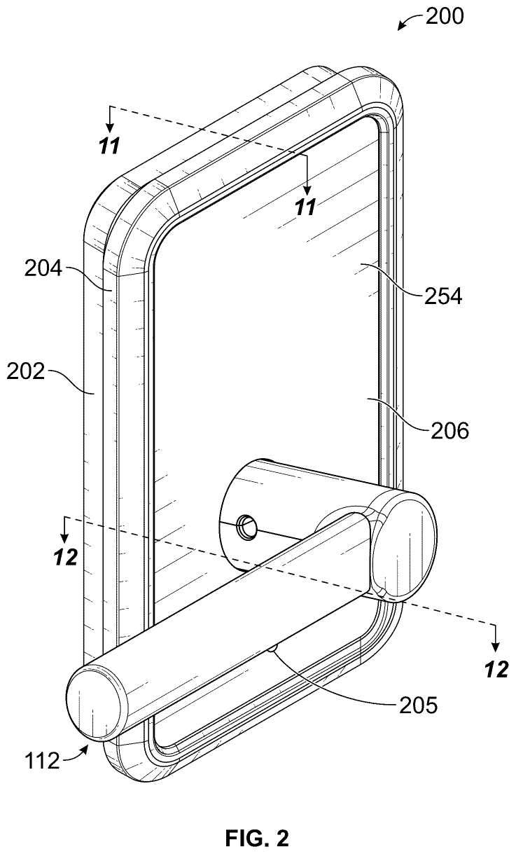

FIG. 1 illustrates a partially exploded assembly view of an exemplary door hardware apparatus 100 that is mounted to a door 90. The door 90 can include an inner or egress side 92, an outer or non-egress side 94, and a free edge 93 extending between and connecting the two sides 92, 94. The door hardware apparatus 100 can include a trim assembly 200 (FIG. 2) that can be mounted to either the egress side 92 or the non-egress side 94 of the door 90, or a pair of trim assemblies 200 wherein a trim assembly 200 is mounted to each of the egress side 92 and the non-egress side 94 of the door 90. The door hardware apparatus 100 can further include a latch mechanism 120 coupled to at least an escutcheon or base 202 of the trim assembly 200, such as, for example, via one or more mechanical fasteners 128, including, for example, bolts and/or screws, among others. According to certain embodiments, door hardware apparatus 100 can further include a lock mechanism 140 operable to selectively prevent operation of the latch mechanism 120. As described herein, the door hardware apparatus 100 may further include one or more electronic components and/or one or more sensors, which may be at least partially housed within a front pocket 220 of the escutcheon or base 202.

The latch mechanism 120 can include a housing 122 and a latchbolt 124, the latchbolt 124 being movably mounted to the housing 122. The latch mechanism 120 may be operably connected with the spindle 116 such that rotation of the spindle 116 causes retraction of the latchbolt 124. While the illustrated apparatus 100 includes the latch mechanism 120, it is also contemplated that the latch mechanism 120 may be omitted. For example, the trim assembly 200 may be provided as a dummy trim that is not connected to a latch mechanism. As another example, the latch mechanism 120 may be replaced by a roller latch.

The trim assembly 200 can include a handle 112 that is coupled to the latch mechanism 120 via a spindle 116. In the illustrated embodiment, the handle 112 is depicted as a lever handle, and generally includes a shank 113 extending along a primary axis 101 and a grip portion 114 extending laterally from the shank 113. It is also contemplated that the handle 112 may be provided in another form, such as that of a knob handle. In the illustrated form, the spindle 116 extends through an opening in the door 90, as well as one or more openings in the trim assembly 200, including, for example, an opening 208a in the escutcheon 202. Further, the trim assembly 200 can be configured such that the handle 112 is rotably mounted to the spindle 116 such that the primary axis 101 is a rotational axis of the handle 112. It is also contemplated that that the spindle 116 may have a fixed orientation, for example in embodiments in which the first trim assembly 200 is provided as a dummy trim.

In certain embodiments, the door hardware apparatus 100 can further include a lock mechanism 140 operable to selectively prevent the handle 114 of the trim assembly 200 on at least one side of the door 90 from actuating the latch mechanism 120. In certain embodiments, the lock mechanism 140 can include an actuator 142 accessible from one side, such as from the egress side 92 of the door 90. According to certain embodiments, the actuator 142 can project through an aperture 205a (FIG. 2) that extends through one or more portions of the trim assembly 200, including through a portion of the aperture 205 provided by an aperture 205a in the escutcheon 202. The actuator 142 can be movable between a first locking position and a second unlocking position to transition the lock mechanism 140 between a locking state and an unlocking state. In the locking state, the lock mechanism 140 prevents a handle, including, for example, an outside handle located at the opposite, ingress side 94 of the door 114, from actuating the latch mechanism 120. With the lock mechanism 140 in the unlocking state, the outside handle can be operable to actuate the latch mechanism 120. While other forms are contemplated, in the illustrated embodiments, the locking position of the actuator 142 is a depressed position, and the unlocking position of the actuator 142 is a projected position. Additionally, while the actuator 142 of the illustrated embodiment projects through the trim assembly 200, it is also contemplated that the actuator 142 may be mounted elsewhere, such as on the interior handle 112. Additionally, or alternatively, lock mechanisms that selectively prevent actuation of an outside handle can also be used with, or part of, the door hardware apparatus 100.

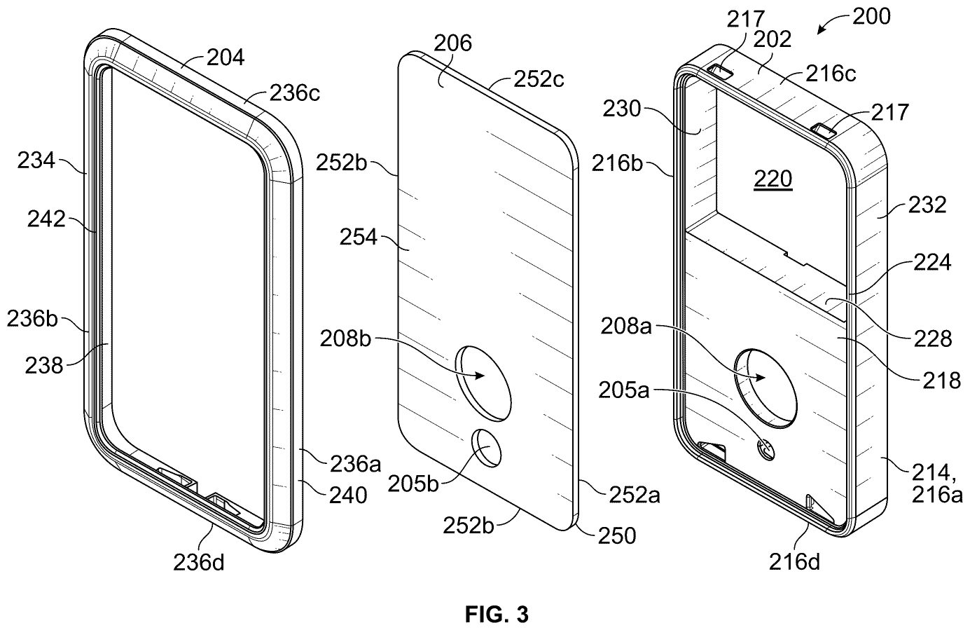

FIGS. 2 and 3 illustrate a front side perspective view, and an exploded front side perspective view, respectively, of an exemplary trim assembly 200 that includes a handle 112. The trim assembly 200 can include an escutcheon 202, a trim insert 206, and, optionally, a bezel 204. An opening 208 can extend through both the escutcheon 202 and the trim insert 206 to accommodate the handle 112 being coupled to the spindle 116, which may at least partially protrude into/from the opening 208, such that the handle 112 can rotate about the primary axis 101.

Referencing FIGS. 3, 4, and 5, the escutcheon 202, which can, for example, be constructed from a metallic material, among others, can include a portion of the opening 208, as indicated by the opening 208a in the escutcheon 202 shown in at least FIG. 3. The escutcheon 202 can also include a perimeter wall 214 having a first sidewall 216a, a second sidewall 216b, a top wall 216c, and a bottom wall 216d. The perimeter wall 214 can further include an inner side 230 and an opposing outer side 232 that extend about at least a portion, if not the entirety, of the perimeter wall 214. In certain embodiments, the escutcheon 202 can further include a backing wall 218 extending between the inner sides 230 of portions of the opposing first sidewall 216a and second sidewall 216b, as well as between an intermediate wall 228 and either or both the top wall 216c and the bottom wall 216d of the perimeter wall 214.

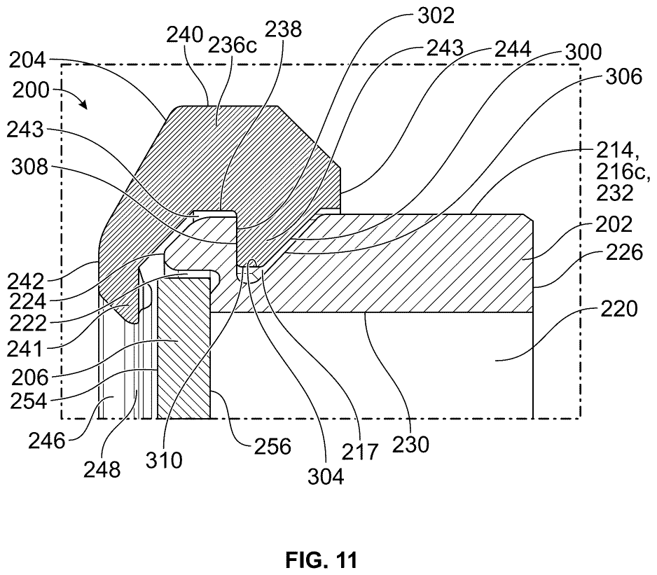

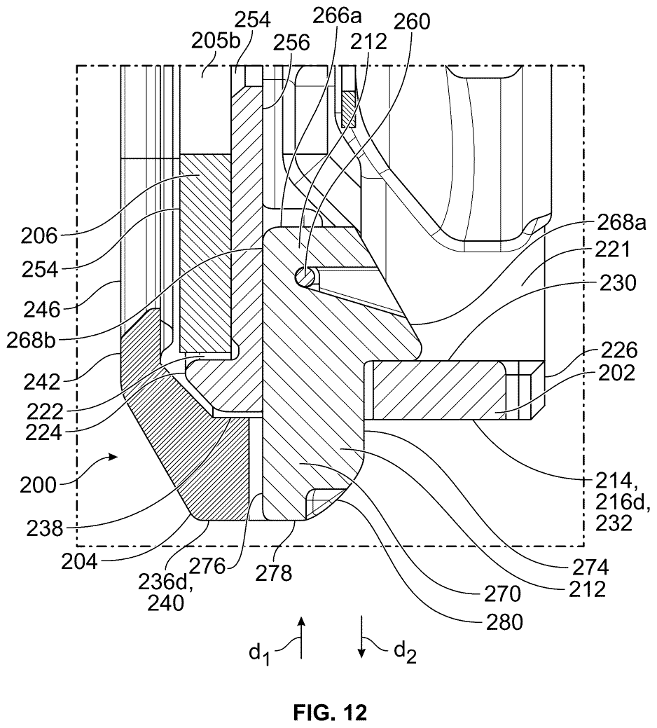

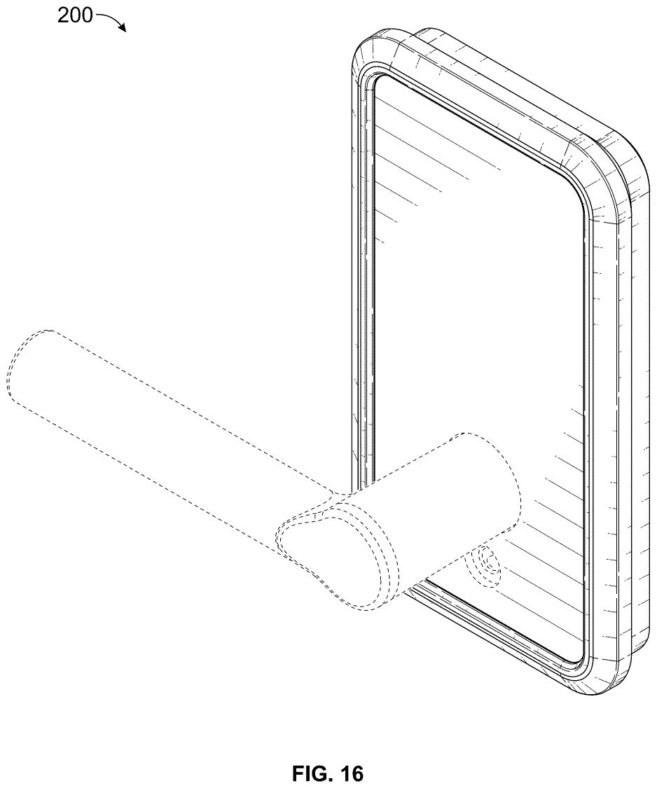

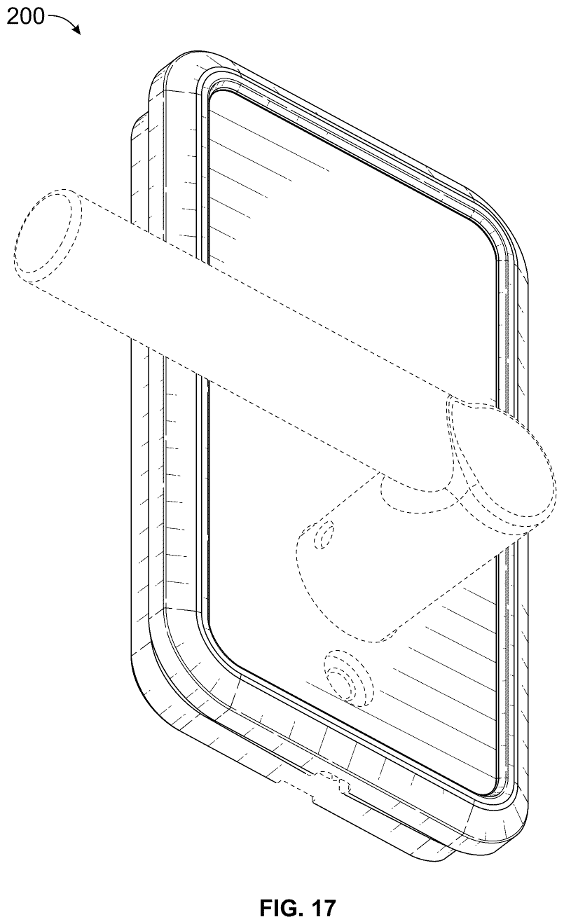

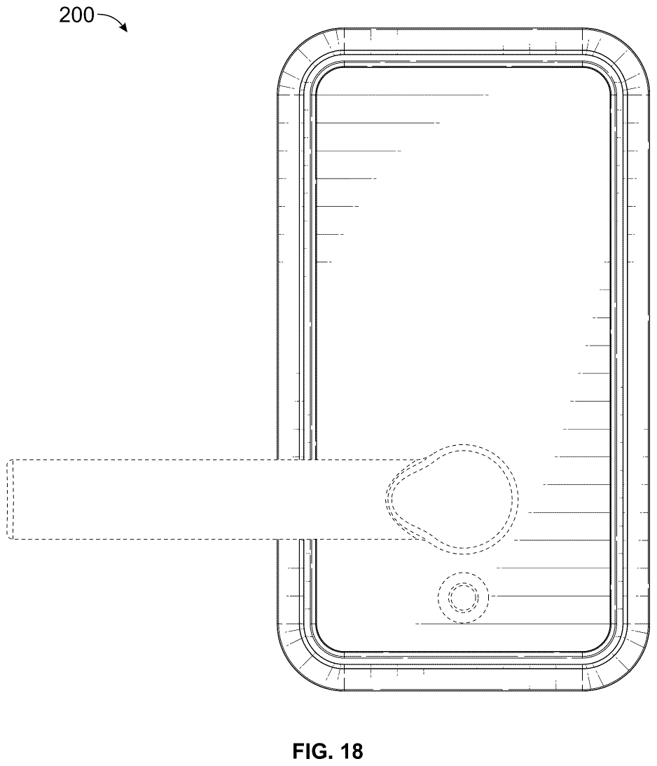

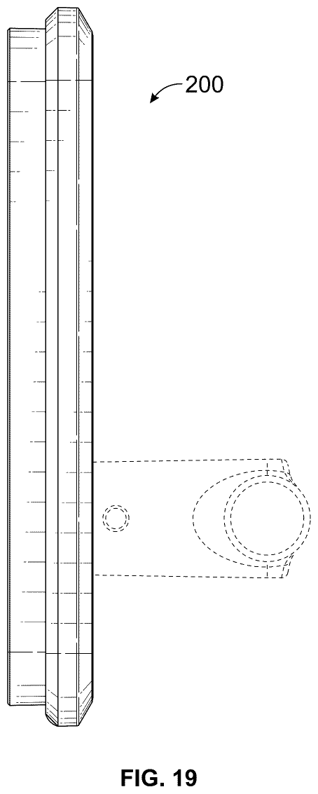

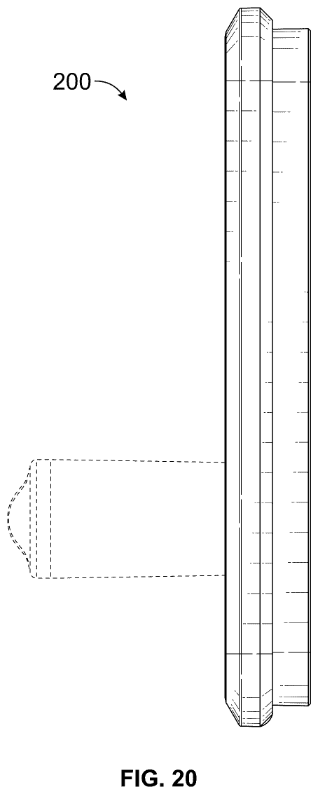

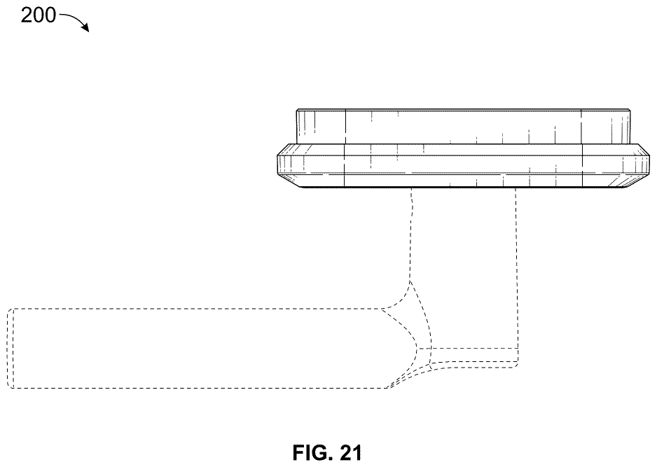

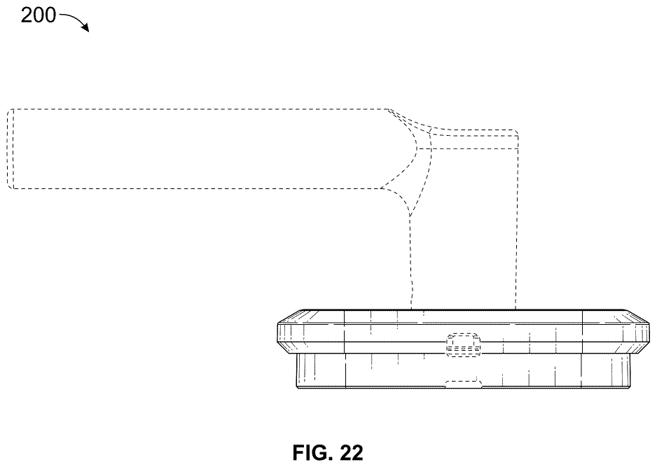

In the illustrated exemplary embodiment of the trim assembly 200 shown in at least FIGS. 2 and 16-22, both the backing wall 218 and the intermediate wall 228 of the escutcheon 202 can be inwardly offset from a front side 224 of the escutcheon 202, and thus, inwardly offset from a front portion of the adjacent portions of perimeter wall 214. Such an offsetting can be sized to accommodate a formation of a pocket 222 at the front side 224 of the escutcheon 202 that can receive placement of at least a portion of the trim insert 206, as well as for a back side 256 of the trim insert 206 to be positioned against at least the backing wall 218 and adjacent portions of the perimeter wall 214. Moreover, such a pocket 222 can be configured to at least assist in the positioning of the trim insert 206 at a location about the trim assembly 200 at which, based on the corresponding thickness of the trim insert 206, at least a front side 254 of the trim insert 206 can be aligned with, or, alternatively, outwardly protruding from, the front side 224 of the escutcheon 202, as seen, for example, in FIGS. 11 and 12.

According to certain embodiments, the escutcheon 202 can include a first pocket 220, which is illustrated in FIG. 3 as an upper first pocket 220. Further, according to certain embodiments, the first pocket 220 can extend through the opposing front side 224 and back side 226 of the escutcheon 202, the back side 226 being positioned, when the trim assembly 200 is mounted to a door 90, adjacent to, if not abutting, the door 90. Additionally, the first pocket 220 can also be generally defined by adjacent portions of first sidewall 216a and second sidewall 216b, and between the intermediate wall 228 and either the top wall 216c or the bottom wall 216d. Optionally, the first pocket 220 can be sized, for example, to accommodate placement of one or more electrical, mechanical, and/or electromechanical components of door hardware apparatus 100, among other components. Alternatively, the first pocket 220 can, at the back side 226 of the escutcheon 202, be at least partially enclosed by a back wall that can extend from at least one of the top wall 216c and the bottom wall 216d to the intermediate wall 228.

According to certain embodiments, a lower, second pocket 221 of the escutcheon 202 can generally be defined by an area between a rear side of backing wall 218 and the back side 226 of escutcheon 202, and which, similar to the backing wall 218. Additionally, the second pocket 2221 can be bordered by adjacent portions of first sidewall 216a and second sidewall 216b, and further extend between either the top wall 216c or the bottom wall 216d and the intermediate wall 228. Similar to the first pocket 220, the second pocket 221 can be sized, for example, to accommodate placement of one or more electrical, mechanical, and/or electromechanical components of door hardware apparatus 100, among other components.

Additionally, according to other embodiments, the perimeter wall 214 of the escutcheon 202 can generally define a continuous first pocket 220 or second pocket 221, or a plurality of pockets, along at least a portion, if not the entirety, of the escutcheon 202. According to such embodiments, the pocket(s) can be located within the inner side 230 of the perimeter wall 214, and extend through either or both the front side 224 and the back side 226 of the escutcheon 202. Additionally, while at least FIG. 5 illustrates the second pocket 221 being below the first pocket 220, according to other embodiments, the second pocket 221 can be above, or side-by-side to, the first pocket 220.

Referencing FIGS. 3, 9, and 10, the bezel 204 can include a perimeter wall 234 having a first sidewall 236a and an opposing second sidewall 236b, as well as a top wall 236c and a bottom wall 236d. The perimeter wall 234 of the bezel 204 can also have opposing inner and outer sides 238, 240, the outer side 240 generally extending about the outer periphery of the bezel 204 and/or perimeter wall 234. At least a portion of the inner side 238 of the bezel 204 can have a profile configured to matingly engage at least the outer side 232 of the escutcheon 202. Additionally, the perimeter wall 234 of the bezel 204 can extend between opposing front and rear sides 242, 244 of the bezel 204, the back side 244 of the bezel 204 being positioned, when the trim assembly 200 is mounted to the door hardware apparatus 100 on a door 90, to be closer to the door 90 than the front side 242.

At least a portion of the inner side 238 of the perimeter wall 234 of the bezel 204 that extends to the back side 244 of the bezel 204 can define a rear opening 248 of the bezel 204 that is sized to receive at least a portion of the outer side 232 of the escutcheon 202 and/or perimeter wall 214 of the escutcheon 202 in connection with at least securely coupling, including attaching or mounting, at least the bezel 204 to the escutcheon 202. The coupling of the bezel 204 to the escutcheon 202 can, according to certain embodiments, be aided by one or more, if not a plurality, of protrusions 243 that can inwardly extend from one or more sidewalls 236a-d of the perimeter wall 234 of the bezel 204 and be received by one or more mating cavities 217 (FIG. 5) in the escutcheon 202. Additionally, the rear opening 248 can be sized to receive placement, or house, the trim insert 206 within the rear opening 248 at a location at which the trim insert 206 can securely abut, or otherwise be adjacent to, at least a portion of the escutcheon 202.

The bezel 204 can also include a front wall 241 that is adjacent to the front side 242 of the bezel 204, and which can inwardly extend from at least a portion of the perimeter wall 234. Moreover, the front wall 241 can inwardly extend along, or from, at least some, if not all, of the walls 236a-d of the perimeter wall 234 of the bezel 204 around the front side 242 of the bezel 204. The front wall 241 can generally define a front opening 246 at, or around, the front side 242 of the bezel 204, the front opening 246 being smaller than, and in fluid communication with, the rear opening 248. Thus, the front opening 246 and the rear opening 248 can provide a through-hole through the bezel 204.

The size difference between the rear opening 248 and the smaller front opening 246 of the bezel 204 can be configured for the front wall 241 to provide a barrier, or otherwise assist in preventing, the passage of the trim insert 206 through the front opening 246. Moreover, the front wall 241 can be sized to accommodate, if not maximize, visual exposure to a front side 254 (FIG. 2) of the trim insert 206 at least when the trim assembly 200 is mounted to the door hardware apparatus 100, as seen, for example, by at least FIG. 2, while also at least assisting in retaining the trim insert 206 within the trim assembly 200.

Referencing FIGS. 2, 3, 11, and 12, the trim insert 206 includes a perimeter wall 250 having opposed first and second sidewalls 252a, 252b as well as a top wall 252c and bottom wall 252d. The trim insert 206 can also extend between opposing front and back sides 254, 256 of the trim insert 206. A portion of the aperture 205 can extend through trim insert 206, as represented in the figures by aperture 205b in trim insert 206. Similarly, a portion of the opening 208 also can extend through the trim insert 206, as represented in the figures by opening 208b in trim insert 206. The perimeter wall 250 of the trim insert 206 can be sized to accommodate placement or housing of trim insert 206 in rear opening 248 of bezel 204, as previously discussed. Further, as also previously discussed, at least a portion of trim insert 206, including front side 254, can be constructed of a material, such as, for example, plastic, among others, suitable for printing, including, for example, screen and/or laser printing, among other printing techniques.

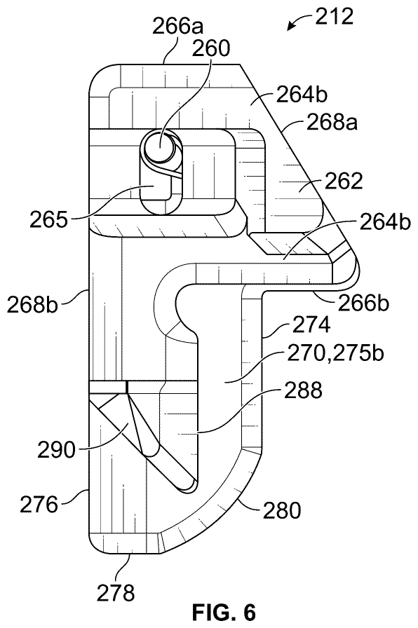

FIGS. 6, 7, and 8 illustrate an exemplary embodiment of a latch assembly 212 configured for securing the assembled trim assembly 200 together and/or to the door hardware apparatus 100. The illustrated latch assembly 212 can include a latch 262 that is coupled to one or more biasing elements 260, the biasing element(s) 260 being configured to provide a force that biases the latch portion 262 to an extended, locked position, as shown in at least FIG. 12.

In the depicted embodiment, the latch 262 includes a body portion 263 having opposed first and second sides 264a, 264b, top and bottom walls 266a, 266b, and opposing face and rear walls 268a, 268b. The body portion 263 can have one or more apertures 265 that can extend into, and/or between, the first and second sides 264a, 264b. In certain embodiments, the aperture 265 can be a through-hole within the body portion 263. The aperture(s) 265 can be configured to receive, and/or house, a portion of one or more biasing elements 260 that can outwardly extend from the latch 262. According to certain embodiments, the biasing element 260, which can, for example, be a spring wire, can traverse through the body portion 263 and outwardly project from both sides 264a, 264b of the body portion 263.

The biasing element 260 can also securely abut, and/or be coupled to, the escutcheon 202 to generally retain the biasing element 260 in engagement with the escutcheon 202. For example, referencing FIG. 5, the escutcheon 202 can include one or more retention tabs 219 on opposing sides of the latch 262 that can provide at least partially confined openings or spaces that can receive at least portion of the biasing element 260, such as, for, example an end and/or areas adjacent to an end, of the biasing element 260. Moreover, the retention tabs 219, which in the illustrated example can extend from the backing wall 218 into the second pocket 221 at a sloped or inclined angle that is non-parallel and non-perpendicular to the backing wall 218, can provide an area that can accommodate movement of the biasing element 260 associated with a bending or deflection of the biasing element 260 as the biasing element 260 is either asserting a biasing force to retain the latch 262 at the extended, locked positioned or as the biasing force of the biasing element 260 is overcome while the latch 262 is displaced to the retracted, unlocked position.

The latch 262 can include a locking tab 270 that extends from the bottom wall 266b of body portion 263. The locking tab 270 can include opposing front and rear walls 274, 276, as well as opposing first and second sides 275a, 275b. The front and rear walls 274, 276 of the locking tab 270 can downwardly extend to a bottom wall 278 of the locking tab 270. Additionally, the locking tab 270 can include a transition wall 280 between front wall 274 and bottom wall 278, the transition wall 280 being configured to facilitate rotational displacement of bezel 202 about escutcheon 202 during at least coupling and/or decoupling of the bezel 204 to/from the escutcheon 202. According to certain embodiments, transition wall 280 can have a rounded or curved shape.

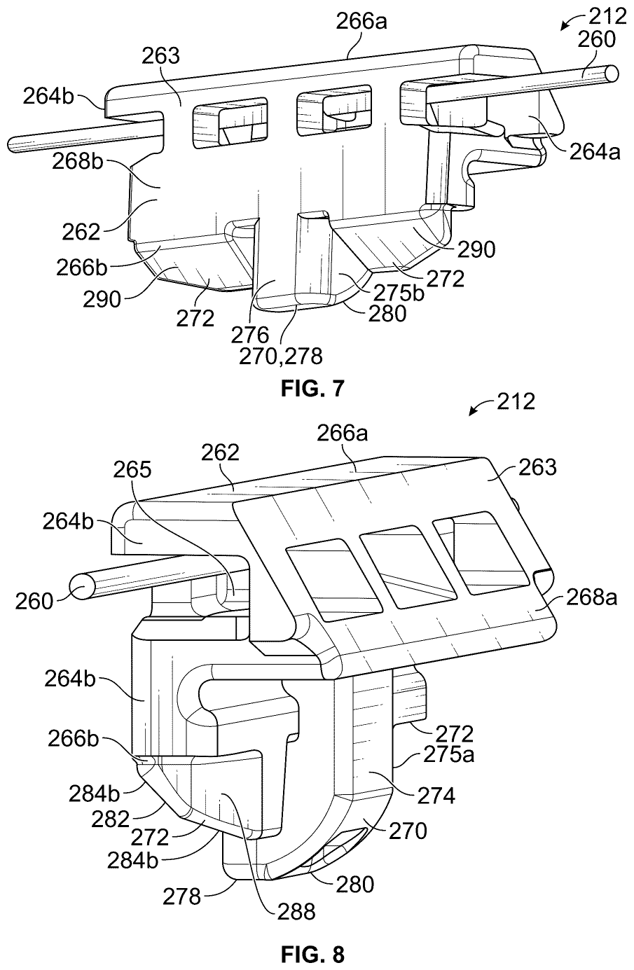

In the illustrated embodiment, the latch 262 can include one or more, if not a plurality, of locking bodies 272 that can extend from either side of locking tab 270, and which are positioned on opposing sides of the first and second sides 275a, 275b of locking tab 270. An outer perimeter wall 282 can extend around each the locking bodies 272 from the locking tab 270 to an adjacent portion of the bottom wall 266b of the body portion 263. In certain embodiments, the outer perimeter wall 282 comprises a plurality of walls or segments, including first and second portions 284, 286, that redirect the outer perimeter wall 282 about the locking body 272. Additionally, each locking body 272 can include a front wall 288 and a rear wall 290. As seen in at least FIGS. 7 and 8, the bottom wall 278 of the locking tab 270 can be vertically offset, including lower, than the lowest portion of the 272 locking bodies 270 such that the locking tab 270 extends further downwardly than the locking bodies 270.

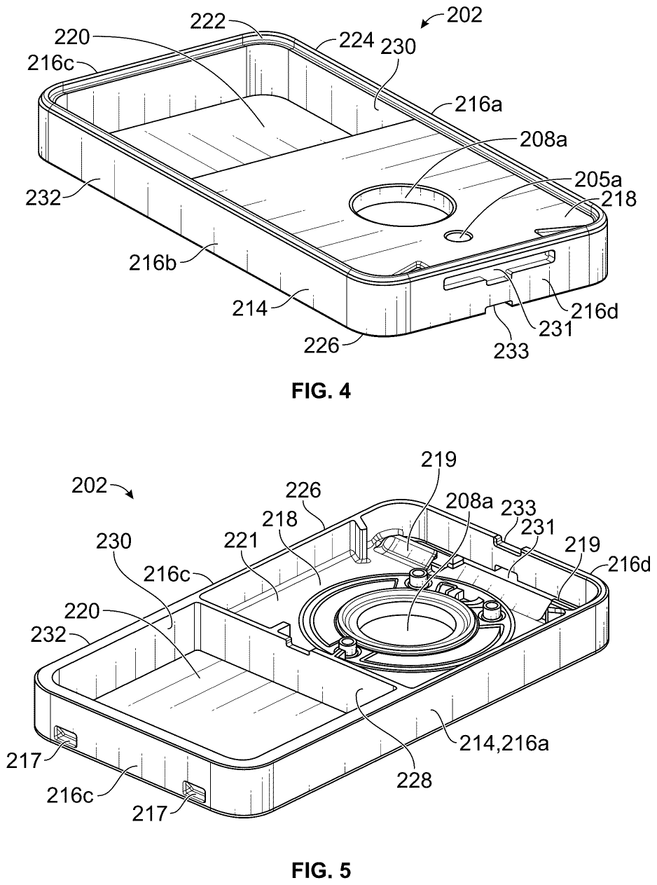

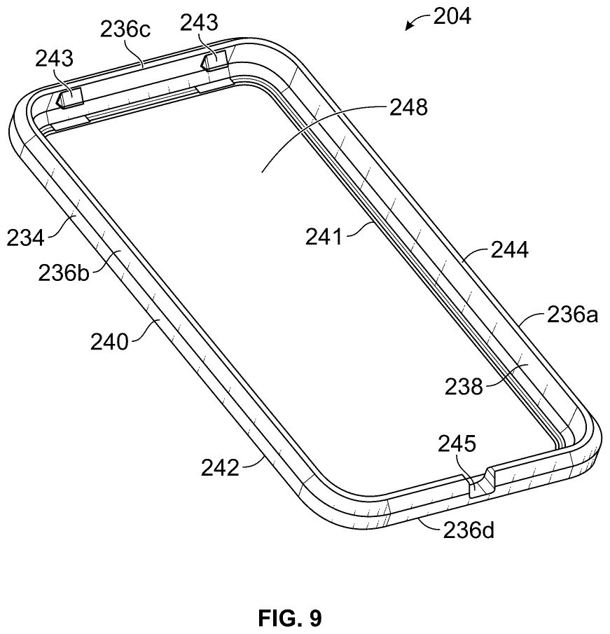

As seen in at least FIG. 4, either or both the bottom wall 216d and the top wall 216c of the perimeter wall 214 of the escutcheon 202 can include an opening 231 through which a portion of the latch 262, and, moreover, the locking body 272 and/or locking bodies 272 can extend, as well as be laterally displaced in connection with displacement of the latch 262 between the extended, locked and retracted, unlocked positions. Additionally, as seen in at least FIG. 9, according to certain embodiments, the perimeter wall 234 of the bezel 204 can include a notch 245 positioned, when the trim assembly 200 is assembled, adjacent to at least a portion of the opening 231 of the escutcheon 202. Moreover, the notch 245 which extends through or around the perimeter wall 234 of the bezel 204, can accommodate selective engagement with a portion of the latch 262, such as the bottom wall 278 of the locking tab 270, by an operator, including installer, of the trim assembly 200. Such engagement can accommodate selective exertion of a force against the locking tab 270 that can overcome the biasing force of the biasing element 260 so that the latch 262 can be, at least temporarily, displaced away from the extended, locked position. Moreover, such selective displacement of the latch 262 can be utilized, for example, in connection with selective detachment of the bezel 204 from the escutcheon 202, and an associated removal/replacement of the trim insert 206 from the trim assembly 200.

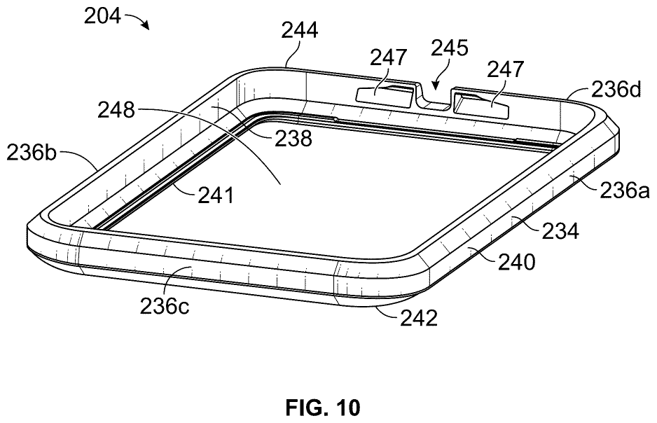

As seen in at least FIG. 10, either or both of the bottom wall 236d and the top wall 236c of the bezel 204 can include one or more recesses 247 positioned to receive a mating locking body 272 of the latch 262 at least when the latch 262 is in the locked position. According to certain embodiments, the recesses 247 may extend only partially into the corresponding sidewall 236c, 236d such that the recesses 247 are not through-holes. The placement of the locking bodies 272 into the mating recess 247 of the bezel 204 can, when the latch 262 is in the extended, locked position, assist in locking the bezel 204, and thus the trim insert 206 positioned or housed within the bezel 204, to the escutcheon 202. Further, the recesses 247 can be sized, such as have a depth, such that when the latch 262 is displaced to the unlocked position, the locking bodies 272 are removed from the mating recesses 247.

According to certain embodiments, the bezel 204 can be coupled to the escutcheon 202 using the latch assembly 212 and the placement of the protrusions 243 of the bezel 204 into mating cavities 217 of the escutcheon 202. For instance, during the installation of the trim assembly 200, the escutcheon 202, with the latch assembly 212 attached to the escutcheon 202, can be connected to the door hardware apparatus 100 by one or more mechanical fasteners. Additionally, the trim insert 206 can be inserted from the back side 244 of the bezel 204 and into the rear opening 248 of the bezel 204 so that front side 254 of trim insert 206 is visible through the front opening 246 of the bezel 204. As previously noted, the front wall 241 of the bezel 204 can prevent the trim insert 206, once positioned within the rear opening 248, from passing through the front opening 246 of the bezel 204. When the trim insert 206 is positioned within the bezel 204, according to the illustrated embodiment, the bezel 204 can be angularly tilted relative to the escutcheon 202 via placement of the protrusions 243 of the bezel in the mating cavities 217 of the escutcheon 202 while the bottom wall 236d of the bezel 204 is positioned away from the escutcheon 202. Such angular tilting of the bezel 204 relative to the escutcheon 202 can be aided by the configurations of the protrusions 243 of the bezel 204 and the mating cavities 217 of the escutcheon 202.

According to certain embodiments, the protrusions 243 of the bezel 204 and the corresponding mating cavities 217 of the escutcheon 202 can possess generally similar, complementary configurations. For instance, as shown in FIG. 11, in certain embodiments, the protrusion 243 can comprise a beveled or inclined wall 300, which can slope downwardly from the inner side 238 of the top wall 236c of the bezel 204, and extend in an angled direction generally toward the front opening 246. Additionally, the beveled wall 300 can slope downwardly to, or toward, an apex of protrusion 243, which may or may not be truncated by a top wall 304 of the protrusion 243. The protrusion 243 can further include a face wall 302, with the face wall 302 and the beveled wall 300 positioned on opposing sides of protrusion 243, as illustrated in FIG. 11. In the illustrated embodiment, the face wall 302 can be generally perpendicular to the adjacent inner side 248 of the top wall 236c.

Similar to the protrusions 243, the mating cavity 217 in escutcheon 202 can have an inclined wall 306 that extends into the escutcheon 202 at an incline that can generally match the slope of the beveled wall 300 of protrusion 243. Further, the cavity 217 can include a recess wall 308 that can generally extend in a direction parallel to the face wall 302 of protrusion 243. The inclined wall 306 and the recess wall 308 of the cavity 217 can converge to generally form a gullet 310 in the cavity 217, the gullet 310 having a configuration, such as size, that can accommodate the placement of top wall 304 of the protrusion 243 within at least a portion of the gullet 310.

The angular orientations of the beveled wall 300 of protrusion 243 and the corresponding inclined wall 306 of the cavity 217 can accommodate rotational displacement of the protrusion 243 within the cavity in a manner in which, when the protrusion 243 is in the mating cavity 217, the bezel 204 can be angularly offset relative to the escutcheon 202. Such angular offsetting, or tilting of the bezel 204 relative to the escutcheon 202 can include the bottom wall 236d of the bezel 204 being offset from the escutcheon 202 such that the bottom wall 236d is disengaged with the bottom wall 216d of the escutcheon 202. The bezel 204 can then be pivotally displaced without interference between the protrusions 243 and the escutcheon 202 such that the bottom wall 236d of the bezel 204 is moved to be below the bottom wall 216d of the escutcheon 202 and/or toward the door 90. As the bottom wall 236d of the bezel 204 continues to be displaced with the pivotal displacement of the bezel 204, the bottom wall 236d can be moved to a position at which the bottom wall 236d contacts either or both the locking tab 270 and locking bodies 272 of the latch 262. Further, the bottom wall 236d of the bezel 204 and either or both the locking tab 270 and locking bodies 272 can be configured such as, for example, have a sloped or inclined surface(s)s, such that, as the bottom wall 236d of the bezel 204 continues being pivotally displaced in a direction generally toward the door 90, the engagement between the bottom wall 236d of the bezel 204 and the locking tab 270 and/or locking bodies 272 can provide a force that overcomes the biasing force of the biasing element 260. Moreover, such engagement between the bottom wall 236d and the locking tab 270 and/or locking bodies 272 can facilitate the latch 262 being at least partially retracted from the extended, locked position. Such retraction of the latch 262 can accommodate further displacement of the bezel 204 at least until the locking tab 270 can extend into the corresponding notch 245 of the bezel 204 and/or the recesses 247 in the bezel 204 are positioned to receive the locking bodies 272 of the latch 262. Consequently, upon the notch 245 and/or recesses 247 of the bezel 204 being moved into position to receive the corresponding locking tab 270 and/or locking bodies 272, the biasing force of the biasing element 260 can exert the biasing force to place at least a portion of the locking tab 270 in the notch 245 and/or a portion of the locking bodies 272 into the mating recess 247 as the latch 262 is moved back toward the extended position. With the latch 262 thereby at least partially positioned in either or both the notch 245 and/or recesses 247 of the bezel 204, and the protrusions 243 of the bezel 204 in the cavities 217 of the escutcheon 202, the bezel 204 can be securely coupled to the escutcheon 202.

In addition to the latch assembly 212 being used to secure the bezel 204 to the escutcheon 202, the generally straight or flat angular orientations of the face wall 302 of the protrusion 243 and of the adjacent, or abutting, recess wall 308 of the cavity 217 can also provide a barrier between the protrusion 243 and the escutcheon 202. Such a barrier can be utilized to resist backing, or sliding, of the protrusion 243 out from the cavity 217, thereby further assisting in resisting inadvertent decoupling of the bezel 204 from the escutcheon 202.

When decoupling the bezel 204 from the escutcheon 202, such as, for example, in instances involving replacement or alteration of the trim insert 206, an operator can insert an implement through at least the notch 245 in the bezel 204 to engage the latch 262 in a manner that can retract the latch assembly 212. Moreover, the inserted implement can be used to counteract the biasing force provided by the biasing element 260, allowing the latch 262 to retract to disengage the latch 262 from the bezel 204, including removing either or both the locking tab 270 and locking bodies 272 from the corresponding notch 245 and recesses 247 in the bezel 204. Upon retraction of the latch 262 from its extended, locked position, the bezel 204 can be pivoted around the top wall 236c, thereby enabling at least the bottom wall 236d of the bezel 204 to pivot away from the escutcheon 202. The bottom wall 236d of the bezel 204 can continue to be pivoted away from the escutcheon 202 until the bottom wall 236d of the bezel 204 has cleared the front side 224 of the escutcheon 202. Once the bottom wall 236d of the bezel 204 has cleared the front side 224 of the escutcheon 202, the bezel 204 can be lifted relative to the escutcheon 202, allowing the protrusions 243 of the bezel 204 to be withdrawn from the mating cavities 217 of the escutcheon 202, thereby completing the decoupling of the bezel 204 from the escutcheon 202. Consequently, the trim insert 206 that had been at least partially positioned within the bezel 204 can become accessible for replacement or modification.

While the aforementioned example describes the latch 262 engaging with the bottom wall 236d of the bezel 204, and the protrusions 243 and mating cavities 217 being located in the top walls 236c, 216c of the bezel 204 and escutcheon 202, respectively, such features can be situated at various other positions around the corresponding perimeter walls 214, 234 of the bezel 204 and escutcheon 202. Further, while the foregoing discusses the bezel 204 having protrusions 243, and the cavities being in the escutcheon 202, in other embodiments the escutcheon 202 can include the protrusions 243 and the bezel 204 can include the cavities 217. Additionally, the bezel 204 can be coupled, including mounted or attached, to the escutcheon 202 in a variety of different manners, including, for example, via use of an interference fit, press fit, mechanical fasteners (e.g., set screw, screws, pins, bolts, etc.), hook and loop material, and/or adhesives, among others. Additionally, or alternatively, either or both the bezel 204 and the escutcheon 202 can include one or more surface features, including, for example, knurls, among other surface textures, that can facilitate a gripping engagement between the bezel 204 and the escutcheon 202 that can at least assist in retaining an attachment of the bezel 204 to the escutcheon 202.

Alternatively, in other embodiments, the trim assembly 200 may not include the bezel 204. For instance, other configurations can utilize alternative methods to securely couple the trim insert 206 to the escutcheon 202 and/or door hardware apparatus 100, allowing for selective removal, replacement, and/or interchangeability of the trim insert 206 without using a bezel 204. For example, in certain embodiments, the coupling of the trim insert 206 to the escutcheon 202 can be achieved using one or more of adhesives, hook and loop systems, hooks, magnets, stretch and release materials, cam locks, eccentric cam locks, and/or mechanical fasteners to attach the trim insert 206 directly or indirectly to the escutcheon 202 and/or door hardware apparatus 100. Further, the selection of coupling and decoupling methods for the trim insert 206 to/from the escutcheon 202 and/or door hardware apparatus 100 can consider the reusability of the coupling means. For example, in some embodiments, the back side 244 of the trim insert 206 can include a first body having a stretch release adhesive that can be selectively bonded directly to the escutcheon 202, or to a substrate attached to the escutcheon 202. In such configurations, in the event the trim insert 206 is to be decoupled, including removed, from the escutcheon 202, the first body can be stretched to facilitate a release or reduction of the adhesion provided by the stretch release adhesive, thereby enabling the trim insert 206 to be selectively detached from the escutcheon 202 or associated substrate. If the trim insert 206 is to subsequently be placed back onto the escutcheon 202, or associated substrate, such as, for example, after a change in the visual appearance of at least the front side 254 of the trim insert 206, or replaced by another trim insert 206, the stretch release adhesive of the previous or new trim insert 206 can be used to couple/recouple the trim insert 206 to the escutcheon 202.

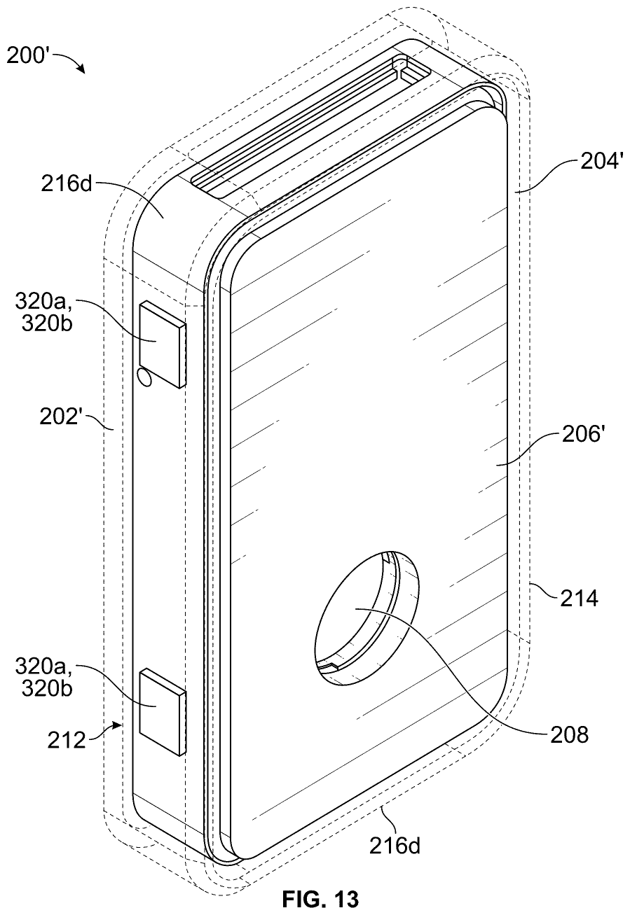

FIGS. 13, 14, and 15 depict an alternative configuration of a latch assembly 200′ in which a bezel 204′ can be coupled to the escutcheon 202′ utilizing one or more magnets 320a, 320b. As illustrated, one or more, if not a plurality, of first magnets 302a can be positioned at various locations along the outer side 232 of the perimeter wall 214 of the escutcheon 202″. Similarly, one or more, if not a plurality of, corresponding second magnets 302b can be arranged at various locations along the inner side 238 of the perimeter wall 234 of the bezel 204′. The positioning of the second magnets 302b on the bezel 204′ can correspond to the positioning of the first magnets 320a on the escutcheon 202′, thereby enabling the first magnets 302a to align with, or be directly opposite to, the corresponding second magnets 302b when the bezel 204′ is coupled to the escutcheon 202″. Furthermore, the polarities of the first and second magnets 320a, 320b can be oriented to produce attractive forces that can facilitate the secure coupling of the bezel 204′ to the escutcheon 202

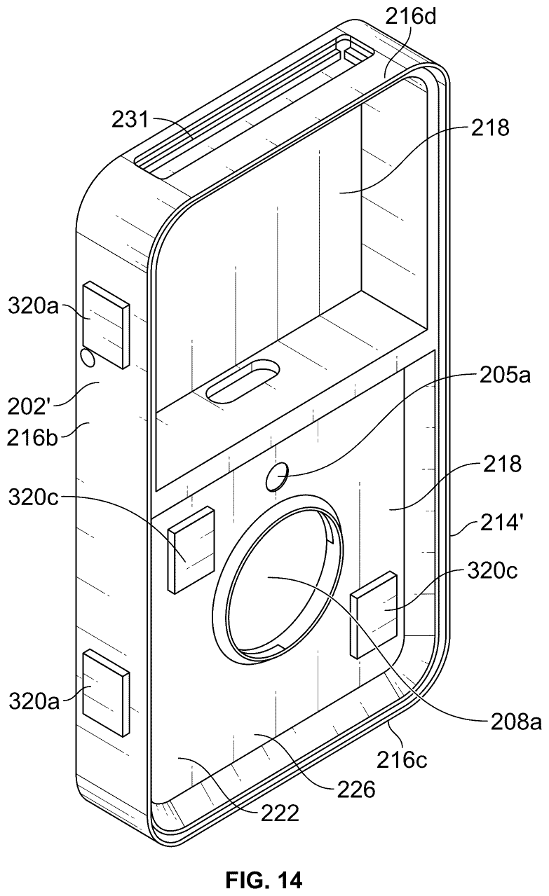

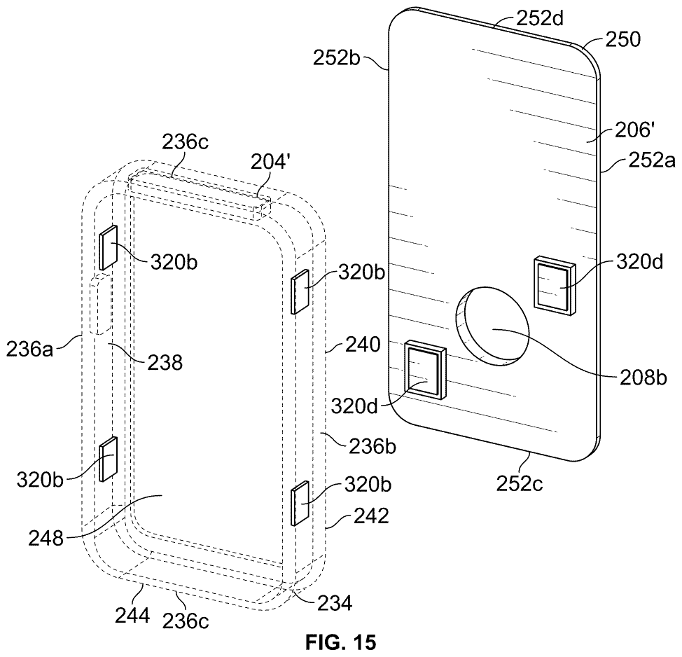

As illustrated in FIGS. 14 and 15, in accordance with certain embodiments, a portion of the backing wall 218 of the escutcheon 202′ adjacent to the front side 224 of the escutcheon 202′ can include one or more, and potentially a plurality of, third magnets 320c. Similarly, the back side 256 of the trim insert 206′ can include one or more, and potentially a plurality of, corresponding fourth magnets 320d. The fourth magnets 320d can be positioned to align with, or be directly oppose to, corresponding third magnets 320c such that an attractive force between the third and fourth magnets 320c, 320d can secure the trim insert 206′ to the escutcheon 202′. While, in certain embodiments, the trim insert 206′ can be retained within the bezel 204′ in a manner similar to that described above with respect to trim assembly 200 shown in at least FIG. 2, with or without the third and fourth magnets 320c, 320d, according to other embodiments, the use of magnets 320a-d can eliminate the need for the latch assembly 212, as well as the mating recesses 243 and cavities of the bezel 204 and the escutcheon 202, respectively. Further, incorporation of the third and fourth magnets 320c, 320d can also facilitate at least some configurations of the trim assembly 200′ that do not include a bezel 204′.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

1. A trim assembly for a door lock, the trim assembly comprising:
a base configured to be secured to a door hardware apparatus;
a bezel, at least one of the bezel and the base having a protrusion and the other of the bezel and the base having a cavity positioned to receive the protrusion;
a trim insert configured to be securely positioned within at least a portion of the bezel, the trim insert having a customizable front side that is at least partially externally visible through a front opening of the bezel; and
a latch coupled to the base and configured for selective displacement between an extended position and a retracted position, the latch being in the extended position to lockingly couple the bezel to the base at least when the protrusion is received in the cavity,
wherein the bezel is configured for a pivotal displacement of the bezel about a location at which the protrusion is received in the cavity, a portion of the bezel being configured to contact the latch during the pivotable displacement to displace the latch from the extended position to the retracted position until the bezel is positioned to be lockingly coupled to the base.

2. The trim assembly of claim 1, wherein the customizable front side of the trim insert is constructed from a printable plastic.

3. The trim assembly of claim 1, wherein the bezel includes a rear opening positioned adjacent to the front opening, the rear opening, and not the front opening, sized to receive placement of the trim insert.

4. The trim assembly of claim 1, wherein the base includes a pocket sized to receive placement of at least a portion of the trim insert at least when the bezel is lockingly coupled to the base.

5. The trim assembly of claim 1, wherein the latch includes a locking body configured to be received in a recess in the bezel when the latch is at the extended position and be removed from the recess upon the latch being displaced from the extended position to the retracted position.

6. The trim assembly of claim 5, wherein the latch includes a locking tab, a portion of the locking tab being accessible through a notch in the bezel when the bezel is lockingly coupled to the base, the locking tab configured to transit a force delivered through the notch that displaces the latch to the retracted position.

7. The trim assembly of claim 1, wherein the base is an escutcheon, and further comprising a latch assembly, the latch assembly comprising the latch and a biasing element, the biasing element coupled to the escutcheon.

8. The trim assembly of claim 7, wherein the biasing element extends through a through hole, and from opposing sides, of the latch.

9. A trim assembly for a door lock, the trim assembly comprising:
a base configured to be secured to a door hardware apparatus;
a bezel having a front opening and a rear opening, the front opening being smaller than the rear opening, the front opening being adjacent to a front side of the bezel, the rear opening being adjacent to a rear side of the bezel;
a trim insert, at least a portion of the trim insert configured to be securely positioned within the rear opening of the bezel, the trim insert having a customizable front side that is at least partially externally visible through the front opening of the bezel; and
a latch assembly coupled to the base, the latch assembly comprising a biasing element and a latch, the biasing element configured to provide a biasing force to bias the latch to an extended position, the latch being selectively displaceable between the extended position and a retracted position, the latch being in the extended position to lockingly couple the bezel to the base.

10. The trim assembly of claim 9, wherein the customizable front side of the trim insert is constructed from a printable plastic.

11. The trim assembly of claim 9, wherein the rear opening, and not the front opening, is sized to receive placement of the trim insert.

12. The trim assembly of claim 9, wherein the base further includes a pocket sized to receive placement of at least a portion of the trim insert at least when the bezel is lockingly coupled to the base.

13. The trim assembly of claim 9, wherein the latch includes a locking body configured to be received in a recess in the bezel when the latch is at the extended position and be removed from recess upon the latch being displaced from the extended position to the retracted position.

14. The trim assembly of claim 13, wherein the latch includes a locking tab, a portion of the locking tab being accessible through a notch in the bezel when the bezel is lockingly coupled to the base, the locking tab configured to transit a force delivered through the notch that displaces the latch to the retracted position.

15. The trim assembly of claim 9, wherein at least one of the bezel and the base includes a protrusion and the other of the bezel and the base includes a cavity positioned to receive the protrusion, and wherein the bezel is configured for a pivotal displacement of the bezel about a location at which the protrusion is received in the cavity, a portion of the bezel being configured to contact the latch during the pivotable displacement to displace the latch from the extended position to the retracted position until the bezel is positioned to be lockingly coupled to the base.

16. A trim assembly for a door lock, the trim assembly comprising:
a base configured to be secured to a door hardware apparatus, the base comprising a base perimeter wall having an outer side, the outer side having a cavity, the base further comprising a first opening in the base perimeter wall and a second opening in a backing wall of the base, the backing wall extending between at least a portion of a pair of opposing sidewalls of the base perimeter wall, the second opening sized to receive insertion of a spindle configured to be coupled to a handle of the door lock;
a bezel having a bezel perimeter wall and a front wall, an inner side of the bezel perimeter wall having a protrusion and a recess, the protrusion and the recess positioned on opposing walls of the bezel perimeter wall, the protrusion positioned to be received within the cavity of the base, the front wall defining a front opening, the bezel perimeter wall defining a rear opening, the front opening being smaller than the rear opening;
a trim insert, at least a portion of the trim insert configured to be securely positioned within the rear opening of the bezel, the trim insert having a customizable front side that is at least partially externally visible through the front opening of the bezel; and
a latch assembly coupled to the base, the latch assembly comprising a biasing element and a latch, the biasing element configured to provide a biasing force to bias the latch to an extended position, the latch being selectively displaceable through the first opening of the base and between the extended position and a retracted position, the latch being in the extended position to lockingly couple the bezel to the base, the latch having a locking body that is removably positioned in the recess of the bezel when the bezel is lockingly coupled to the base.

17. The trim assembly of claim 16, wherein the bezel is configured for a pivotal displacement of the bezel about a location at which the protrusion is received in the cavity, a portion of the bezel being configured to contact the latch during the pivotable displacement to displace the latch from the extended position to the retracted position until the recess of the bezel is positioned to receive the locking body of the latch.

18. The trim assembly of claim 16, wherein the customizable front side of the trim insert is constructed from a printable plastic.

19. The trim assembly of claim 16, wherein the base further includes a pocket sized to receive placement of at least a portion of the trim insert at least when the bezel is lockingly coupled to the base.

20. The trim assembly of claim 16, wherein the latch includes a locking tab, a portion of the locking tab being accessible through a notch in the bezel when the bezel is lockingly coupled to the base, the locking tab configured to transit a force delivered through the notch that displaces the latch to the retracted position.
